(19) United States
(12) Patent Application Publication
(10) Pub. No.: US 2015/0205511 A1
(43) Pub. Date: Jul. 23, 2015

(54) Systems And Methods For An Animated Graphical User Interface

(71) Applicant: Apple Inc., Cupertino, CA (US)

(72) Inventors: Fredric Vinna, Stockholm (SE); Rob Sheridan, Los Angeles, CA (US); Michael Trent Reznor, Los Angeles, CA (US); James Temple, Hitchin Hertfordshire (GB); Scott Elliot Shaw, Tunbridge Wells Kent (GB); Lucio Moreno Rufo, Balham (GB)

(21) Appl. No.: 14/598,729

(22) Filed: Jan. 16, 2015

Related U.S. Application Data
(60) Provisional application No. 61/929,484, filed on Jan. 20, 2014.

(51) Int. Cl. G06F 3/0484; H04L 29/08

(52) U.S. Cl. CPC G06F 3/04847; H04L 67/10

(57) ABSTRACT

Various embodiments of the present disclosure are directed to an electronic device and method providing a plurality of playback indicators for controlling playback of a media object. Playback indicators include playback progress, download progress and volume control indicators. In one example embodiment, the method for controlling playback of a media object on an electronic device includes: receiving an input to initiate playback of the media object using the electronic device; displaying, on a display of the electronic device, a circular progress bar having an inner boundary, an outer boundary, and a first circular progress bar width disposed between the inner boundary and the outer boundary; and during the playback of the media object, radially filling the width of the circular progress bar to graphically depict a playback progress for the media object.

### CROSS REFERENCE TO RELATED APPLICATION

This application claims benefit of U.S. provisional application Ser. No. 61/929,484 filed Jan. 20, 2014, and entitled “Systems and Methods for an Animated Graphical User Interface,” which is hereby incorporated herein by reference in its entirety. This application is related to co-pending U.S. Design Patent Application 29/479,720, filed on Jan. 17, 2014, entitled “Animated Graphical User Interface For A Display Screen,” which is incorporated by reference herein in its entirety.

### FIELD

This application generally relates to controlling playback of a media object. In particular, the application relates to platforms and techniques for controlling playback of a media object using a graphical user interface.

### BACKGROUND

Media services are gaining in popularity as more consumers seek immediate access to comprehensive media libraries. For example, instead of purchasing individual copies of songs or albums (e.g., CDs), videos (e.g., dvds of television shows, movies), printed media (e.g., books, newspapers, magazines), games, and the like, consumers can register with various media services to access media offered by the media services. Particularly, various media services and platforms enable users to download or stream media such as for example specific songs, albums, playlists, television shows, movies, books, newspapers, games, and the like, to desktop applications or mobile devices. One benefit advertised by many media services is the ability to discover new media (e.g., new songs, shows, books, magazines) and/or new media that could be of potential interest to the users. However, there are deficiencies in existing media services and platforms.

For example, existing media services tend to provide graphical user interfaces for controlling the playback of a media object that can lack artistic value or an element of interest. For example, existing interfaces typically include a horizontal bar with a sliding mechanism for controlling media playback, the horizontal bar representing the total play time and the sliding mechanism being movable between a start time and an end time at discrete intervals along the horizontal bar. Accordingly, with the advent and popularity of media services offering users the ability to expand their access to media libraries, there is an opportunity for implementing systems and methods for providing new and inventive graphical user interface techniques for controlling the playback of media.

### SUMMARY OF THE INVENTION

The application is defined by the appended claims. This description summarizes aspects of the embodiments and should not be used to limit the claims. While this description is stated in the context of media services, that is only one example implementation and other implementations are contemplated in accordance with the techniques described herein.

The application is intended to solve the above-noted business and technical problems by providing systems and methods for providing a circular graphical user interface that enables a user to control the playback of media objects in a media service or other software application. In one example embodiment, a method for controlling playback of a media object on an electronic device includes: receiving an input to initiate playback of the media object using the electronic device; displaying, on a display of the electronic device, a circular progress bar having an inner boundary, an outer boundary, and a first circular progress bar width disposed between the inner boundary and the outer boundary; and during the playback of the media object, radially filling the width of the circular progress bar to graphically depict a playback progress for the media object.

### BRIEF DESCRIPTION OF THE DRAWINGS

For a better understanding of the invention, reference can be had to embodiments shown in the following drawings in which:

FIG. 1 is a block diagram illustrating an exemplary environment for implementing a media service, and/or portions thereof, in accordance with embodiments.

FIG. 2 is a diagram of an exemplary device configured to interface with a media service, in accordance with embodiments.

FIG. 3 is a flow diagram illustrating an exemplary method of controlling playback of a media object, in accordance with the embodiments.

FIGS. 4A, 4B, 4C, 4D, and 4E illustrate exemplary interfaces associated with controlling playback of a media object, in accordance with embodiments.

FIG. 5 illustrates an exemplary interface associated with controlling playback of a media object that has been downloaded, in accordance with embodiments.

FIGS. 6A and 6B are flow diagrams illustrating an exemplary method of controlling the playback progress of a media object, in accordance with the embodiments.

FIGS. 7A and 7B illustrates an exemplary interface associated with controlling the playback progress of a media object, in accordance with embodiments.

FIG. 8 is a flow diagram illustrating an exemplary method of pausing the playback of a media object, in accordance with the embodiments.

FIGS. 9A and 9B illustrate exemplary interfaces associated with pausing the playback of a media object, in accordance with embodiments.

FIG. 10 is a flow diagram illustrating an exemplary method of controlling a playback volume of a media object, in accordance with the embodiments.

FIGS. 11A and 11B illustrate exemplary interfaces associated with controlling a playback volume of the media object, in accordance with the embodiments.

### DETAILED DESCRIPTION OF PREFERRED EMBODIMENTS

While the invention can be embodied in various forms, there is shown in the drawings, and will hereinafter be described, some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

Various embodiments of the present disclosure are directed to an electronic device and method providing a plurality of playback indicators for controlling playback of a media object. In some embodiments, the playback indicators include: a circular progress bar indicating the media playback progress (i.e., how long or how much of the media has been playing); download indicator bar indicating how much of the media item has been downloaded to a memory (temporary or permanent) of the electronic device; and a volume control bar indicating the volume level, if any, at which the media is playing. In such embodiments, the electronic device displays the plurality of playback indicators to enable the user to control or modify the playback indicators as desired (for example, to initiate or stop media playback, to move forward or backwards within the media playback, or to adjust the volume of the playback), and to provide information regarding the playback of the media, such as the progress of the playback and download, the remaining time, and the volume at which the media is being played. In one embodiment, each of the playback indicators are circular in shape, and user control of a given indicator includes moving a portion of the indicator in a circular manner.

In accordance with one or more principles of the invention, systems and methods are provided for controlling the playback of media objects by a user during playback and/or during download of the media object from a media service or other software application. According to some embodiments, an electronic device in combination with a media service server can implement the systems and methods that present a graphical user interface for controlling the playback of the media objects. The graphical user interface facilitates the controlling of media playback by displaying a plurality of circular playback indicators and enabling user to modify the playback through circular interactions with the various playback indicators.

As used herein, a “media service” can be understood to be any service, platform, application, or the like that enables a set of users to access and manage media data, such as, for example, media objects or music objects, among other functionalities. Some examples of media service providers include, but are not limited to, Netflix, Amazon, VUDU, Hulu, YouTube, Pandora, Spotify, and Beats Music. Further, as used herein, a “playlist” can be understood to be a listing, indication, or aggregation of one or more songs, tracks, albums, videos, and/or other media data files or objects that are accessible to and manageable by one or more users, and from which the one or more users can select one or more media objects for playback. In some cases, the media data files can be accessible locally to the device from which the user is accessing the playlist. In other cases, the media data files can be accessible via streaming from a remote server or from other devices connected to the device via a network. In certain embodiments, the media service enables users to share music with each other. In some embodiments, the set of users can register with the media service. It should be appreciated that in certain embodiments, while a media object is being played on the electronic device, it is also being downloaded to the electronic device. In such embodiments, the media object can be downloaded to a memory of the electronic device, for example, a permanent memory or a temporary, cache memory.

It should be understood that any music object sharing, identifying, determining, locating, retrieving, providing or the like can be facilitated by an electronic device singularly, or by the electronic device in communication with a server, such as a media service server. An electronic device (for example, smartphone, tablet computer, notebook computer, etc.) can request a server to locate one or more songs. Further, the server can provide any located songs to the electronic device for playback by a user. Further, both the electronic device and the server can execute a media service or similar media service module or application to implement the functionalities as discussed herein.

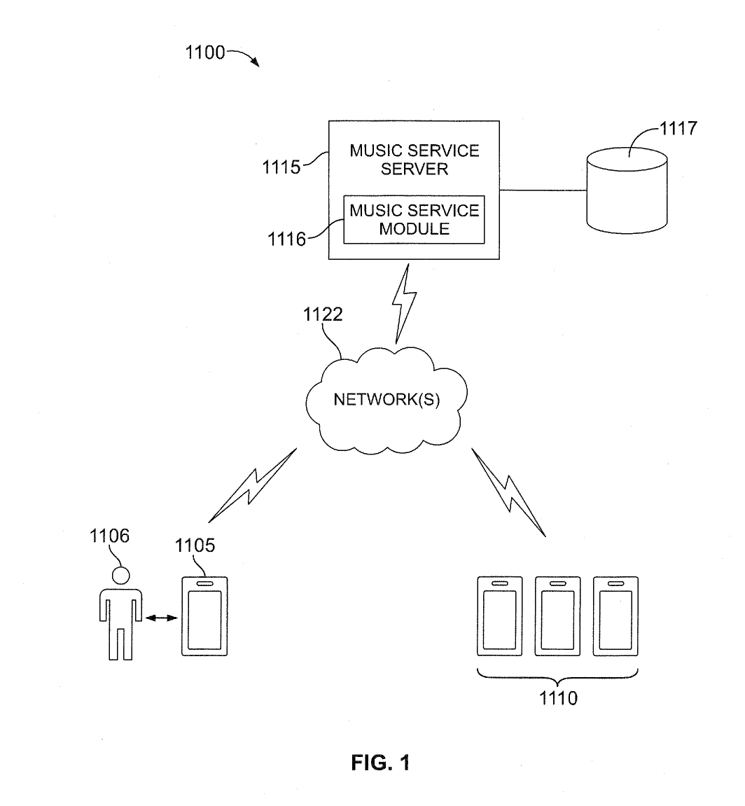

FIG. 1 depicts an environment 1100 comprising components and entities of the embodiments as discussed herein. It should be appreciated that the environment 1100 is merely exemplary and can comprise fewer or more components and entities, as well as other various combinations of components and entities.

As shown in FIG. 1, the environment 1100 comprises a device 1105 configured to communicate with a media service server 1115. In embodiments, it should be understood that the device 1105 can be any type of electronic device, for example, a smart phone, a notebook or desktop computer, a tablet device, a personal data assistant (PDA), or the like, comprising any type of hardware or software components, or combinations thereof. The device 1105 can execute a media service application (not shown) configured to facilitate the functionalities as discussed herein. As shown in FIG. 1, a user 1106 can interface with the device 1105 and/or the media service application thereof to manage various functionalities associated with the components of the environment 1100. The media service server 1115 can comprise a combination of hardware or software components (such as a media service module 1116), or combinations thereof, configured to support the facilitation of a media service, as well as the techniques for controlling media playback as described herein. In some embodiments, the user 1106 of the device 1105 can register for an account or a registration with an associated media service and the media service server 1115 and components thereof can provide music data or objects to the device 1105 in accordance with a subscription of the user 1106. For example, in some cases, the user 1106 can select to download songs, tracks, play list files including songs, and/or other music objects from the media service server 1115 to the device 1105. In other cases, the media service server 1115 can stream songs, tracks, play list files including songs, and/or other music objects to the device 1105 for access and consumption by the user 1106.

In embodiments as shown, the media service server 1115 can couple to storage 1117 that can be configured to store data associated with the media service server 1115. For example, the storage 1117 can store any associated music data as well as data related to subscriptions and other account information for users of the media service server 1115. The device 1105 can connect to the media service server 1115 via a network 1122, for example, a wide area network (WAN), a local area network (LAN), or other networks. The network 1122 can facilitate any type of wireless data communication via any wireless communication standard or technology (e.g., GSM, CDMA, TDMA, WCDMA, EDGE, OFDM, GPRS, EV-DO, WiMAX, WiFi, Bluetooth, UWB, short-range wireless, and others). More particularly, the device 1105 can send data to and receive data from the media service server 1115 via the network 1122. For example, the media service server 1115 can receive music data requests from the device 1105 and can transmit or stream music data to the device 1105 according to the requests. In another example, the media service server 1115 can receive indications of the user's musical preferences from the device 1105 and can transmit or stream music data to the device 1105 in accordance with the user's musical preferences.

As shown in FIG. 1, the environment 1100 can further comprise a set of additional devices 1110 that can also be configured to connect to the media service server 1115 via the network 1122. Each of the set of additional devices 1110 can be associated with a set of additional users of the media service implemented by the media service server 1115. According to implementations, the media service server 1115, the device 1105, and the set of additional devices 1110, and components thereof, can facilitate the management of music subscriptions of the users of the respective devices 1105, 1110. More particularly, the media service server 1115 (and the media service module 1116 thereof), the device 1105 (and the media service application thereof), and/or the set of additional devices 1110 can enable the respective users to share music objects with each other. It should be appreciated that the music objects, as described herein, can be any type of music data and information such as, but not limited to, one or more songs, one or more albums, a group of songs by a particular artist, one or more playlists, one or more music videos, various music artwork, and/or other types of media of data.

Users of the device 1105 and/or the set of additional devices 1110 can interface with respective devices 1105, 1110 to initiate a media service or application and manage the functionalities of the media service. The device 1105 and/or the set of additional devices 1110 can communicate with the media service server 1115 to transmit share activity, identify music objects based on the share activity, and access the music objects. In embodiments, a user can select to play a music object, at which point the media service server 1115 can retrieve the appropriate music object from the storage 1117 and provide (for example, by streaming) the music objects to the appropriate device 1105, 1110. In some embodiments, one or more of the music objects can be played from a local cache of the appropriate device 1105, 1110. In further embodiments, one or more of the music objects can be retrieved via a peer-to-peer (P2P) network, or the like, among the device 1105 and the set of additional devices 1110.

According to embodiments, each user of the media service can have an associated music profile that can include any data related to the musical tastes, preferences, listening history, interactions or social network connections with artists and/or other users, listening data or trends, songs or artists that share similarities with other songs or artists that the user enjoys, has listened to, and/or is otherwise associated with the user, and/or any other data that can indicate the songs, bands, artists, genres, and/or musical eras that a user tends to enjoy or not enjoy. In embodiments, the music profile of the user can be based on other users, entities, or music or playlist curators that the user is connected to, “follows,” subscribes to, or is otherwise associated with in the media service.

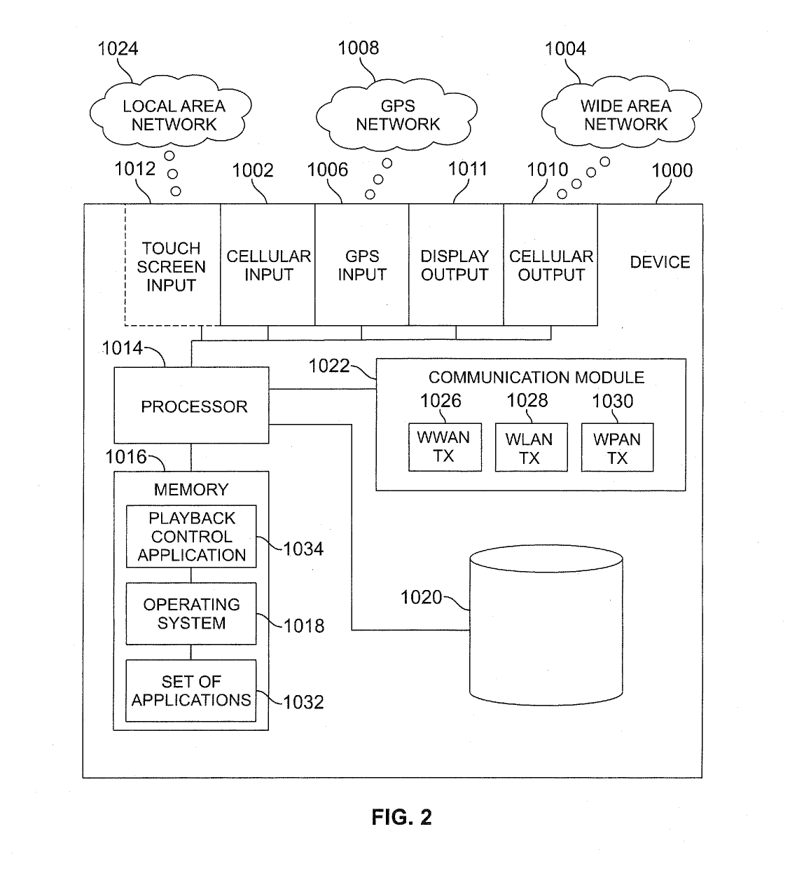

As shown in FIG. 2, a device 1000 can comprise a set of ports that can receive input signals or data from, or output signals or data to, other components of a media distribution environment, such as the environment 1100 as discussed with respect to FIG. 1. More particularly, a cellular input port 1002 can receive cellular data from a wide area network 1004 (such as various private or public networks), a GPS input port 1006 can receive GPS coordinate data from a GPS network 1008, and a cellular output port 1010 can output data to the wide area network 1004. The device can also comprise a display output port 1011 that can send data to a display of the device 1000 for displaying graphical user interfaces and other display data. The device 1000 can further comprise an optional touchscreen input port 1012 that can receive contact-based inputs from interactions with a touchscreen by a user operating the device 1000.

The device 1000 can further comprise a processor 1014 communicating with a memory 1016, such as electronic random access memory (RAM), or other forms of transitory or non-transitory computer readable storage mediums, operating under control of or in conjunction with an operating system 1018. The operating system 1018 can be any commercial, open-source, or proprietary operating system or platform. The processor 1014 can communicate with a database 1020, such as a database stored on a local hard drive. While illustrated as a local database in the device 1000, the database 1020 can be separate from the device 1000.

The processor 1014 can further communicate with a communication module 1022, such as a wired or wireless data connection, which in turn communicates with the wide area network 1004. Further, the communication module 1022 can comprise radio transceivers that communicate with a wireless local area network 1024 or other networks, such as various personal area networks. The communication module 1022 can comprise a WWAN transceiver 1026 capable of communicating with the wide area network 1004, a WLAN transceiver 1028 capable of communicating with the local area network 1024, and a WPAN transceiver 1030 capable of communicating with a personal area network (for example, a short-range wireless network or a Bluetooth® network). Although not shown in FIG. 2, the communication module 1022 can further include various components for communicating with a GPS network.

The set of ports 1012, 1002, 1006, 1010 of the device 1000 can use the components of the communication module 1022 to connect to the entities of the environment 1100. For example, the cellular input port 1002 can receive streaming song data via the WWAN transceiver 1026. The processor 1014 can also communicate with a set of applications 1032 that can be configured to execute control logic and perform data processing to perform the functions and techniques as discussed herein. For example, the set of applications 1032 can comprise a media service application and/or a playback control application 1034 that can provide the interfaces as described herein, receive inputs from the user, and facilitate the communication of data among the entities of the environment 1100. It should be appreciated that other applications 1032 and functionalities thereof are envisioned.

While FIG. 2 illustrates the device 1000 as a standalone system using a combination of hardware and software, the components of the device 1000 can also be implemented as a software application or program capable of being executed by a conventional computer platform. Likewise, the components of the device 1000 can also be implemented as a software module or program module capable of being incorporated in other software applications and programs. In either case, the components of the device 1000 can be implemented in any type of conventional proprietary or open-source computer language.

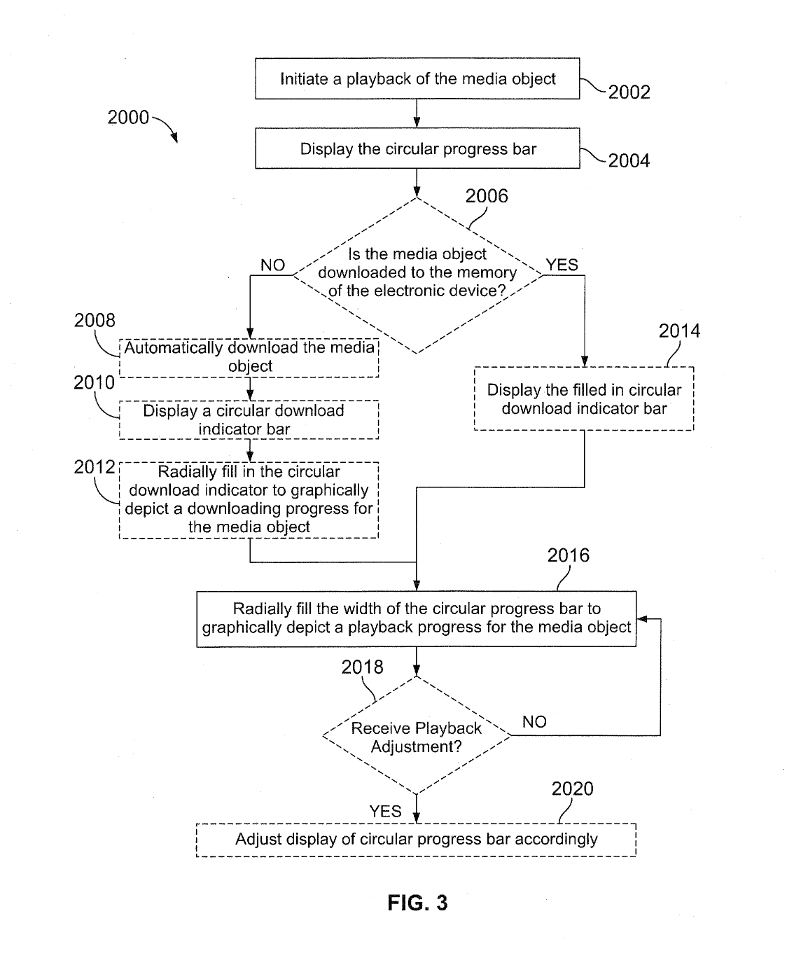

FIG. 3 is a flowchart of one embodiment of a process or method 2000 for an electronic device (for example, device 1105 in FIG. 1) to control the use and/or playback of a media object. It should be appreciated that the functionalities of the method 2000 can be implemented with the electronic device executing an application and interfacing with a remote server, for example, the media service server 1115 in FIG. 1. In various embodiments, the application can be the playback control application or a portion of a media service application, for example, a playback control aspect of the media service application. In some embodiments, the application can be a computer program stored on a non-transitory computer readable medium that is executable by a processor of the device. Further, according to embodiments, the electronic device can include a display and a user interface, and a processor (such as the processor 1014 in FIG. 1) communicatively coupled to the display and the user interface.

In various embodiments, method 2000 is represented by a set of instructions stored in one or more memories and executed by one or more processors. As with the methods described with references to the flow charts discussed below, although method 2000 is described with reference to the flow chart shown in FIG. 3, it should be appreciated that many other processes of performing the acts associated with this illustrated method 2000 can be employed. For example, the order of certain of the illustrated blocks and/or diamonds can be changed, certain of the illustrated blocks and/or diamonds can be optional, and/or certain of the illustrated blocks and/or diamonds can not be employed.

In this example embodiment, the method 2000 includes initiating a playback of the media object using the electronic device as indicated by block 2002. In various embodiments, it should be understood that the electronic device can be any type of device, for example, a smart phone, a notebook or desktop computer, a tablet device, a personal data assistant (PDA), or the like, comprising any type of hardware or software components, or combinations thereof. In this example embodiment, the media object can be any type of media, for example, a song, an album, a playlist, a music video, a book, a movie, or the like. The electronic device can receive, via the user interface, an input to initiate playback. In some embodiments, the input can be a contact-based input detected by the touchscreen of the electronic device or a different type of gesture. For example, the input can be a double-tap/touch gesture, or a single-tap/touch gesture. As another example, the input can be a short tap or a long tap. In some embodiments, the input is to drag an icon, or a portion of an icon, in a certain direction or for a duration of time, or a combination thereof. In some embodiments, the input can be received in association with the multiple icons.

In the example embodiment, after initiating a playback of the media object, the method 2000 includes displaying, on a display of the electronic device, a circular progress bar, as indicated by block 2004. In this embodiment, the circular progress bar includes: an inner boundary, an outer boundary, and a first width disposed between the inner boundary and the outer boundary. During the playback of the media object, the method 2000 includes radially filling the width of the circular progress bar to graphically depict a playback progress for the media object, as indicated by block 2016.

In various embodiments, the method 2000 includes automatically downloading the media object to a memory within the electronic device. It should be appreciated that the media object can be downloaded to a permanent memory or a temporary memory of the electronic device. In some embodiments, for an initial playback of a media object, the method 2000 includes automatically downloading and storing the media object in a cache memory of the electronic device. Consequently, for a subsequent playback of the same media object, the media object can already be downloaded to the cache memory of the electronic device and therefore, does not need to be downloaded again. Thus, the method 2000 includes determining whether the media object has been downloaded to a memory of the electronic device, as indicated by diamond 2006. If the media object has not been downloaded to the memory of the electronic device, the method 2000 includes automatically downloading the media object, as indicated by block 2008.

The method 2000 further includes displaying the download progress of the media object by displaying a circular download indicator bar, as indicated by block 2010. In one embodiment, the download indicator bar includes: an inner boundary, an outer boundary, and a width disposed between the inner boundary and the outer boundary. In this example embodiment, the download indicator bar width disposed between the inner and outer boundary of the download indicator is a second, different width that is less than the first width of the circular progress bar. In another embodiment the download indicator bar width can be equal to or greater than the first width. As indicated in block 2012, the method 2000 includes radially filling the second, different width of the download indicator bar to graphically depict a downloading progress for the media object.

It should be appreciated that in some cases, the method 2000 initiates the automatic downloading of the media object while continuing playback of the media object and continuing to radially fill the width of the circular progress bar, as indicated by block 2016. Thus, in such cases, the method 2000 includes filling both the circular progress bar and the download indicator bar simultaneously to graphically depict the playback progress and the download progress. In other cases, for example, if the media object has already been completely downloaded to a memory of the electronic device, the method 2000 can include displaying a filled-in, or complete, circular download indicator bar, as indicated by block 2014. More specifically, the circular download indicator bar can be fully and radially extended to complete a full circle having a inner boundary, an outer boundary and a download indicator bar width disposed between the inner boundary and the outer boundary. In other embodiments the download indicator bar will not be displayed.

The method 2000 further includes determining whether the electronic device receives a playback adjustment, as indicated by diamond 2018. If there is no playback adjustment, the method 2000 continues radially filling the width of the circular progress bar to graphically depict a playback progress for the media object. If the electronic device receives a playback adjustment, the method 2000 includes adjusting the display of the circular progress bar, as indicated in block 2020 and as will be described in greater detail below.

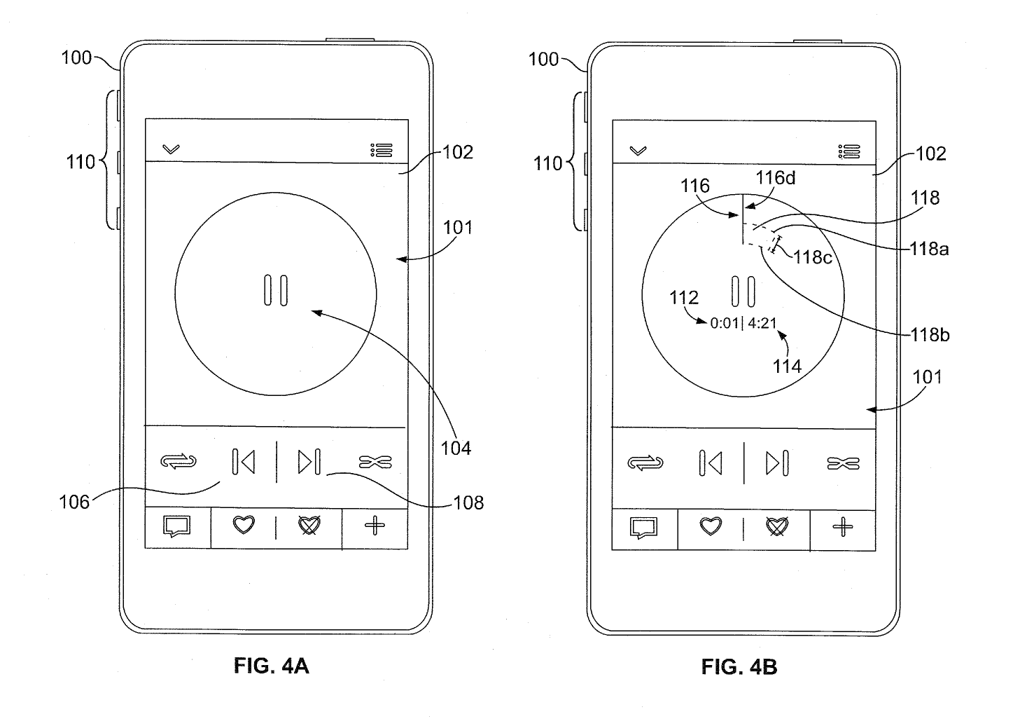

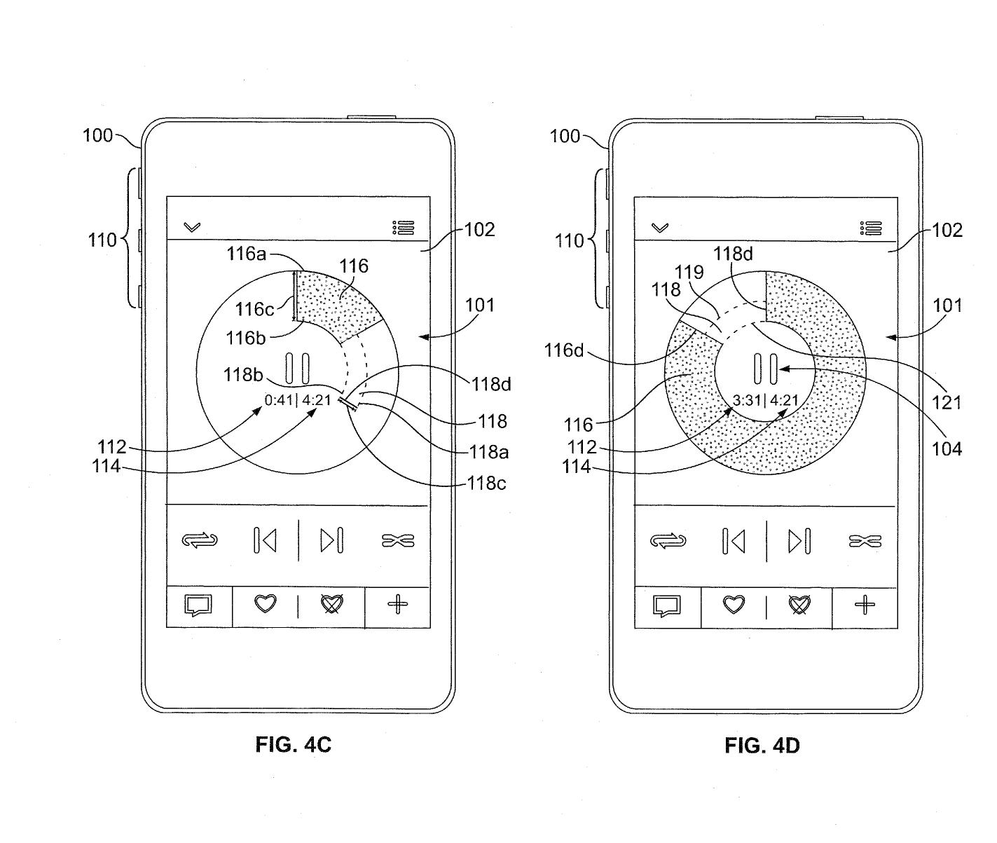

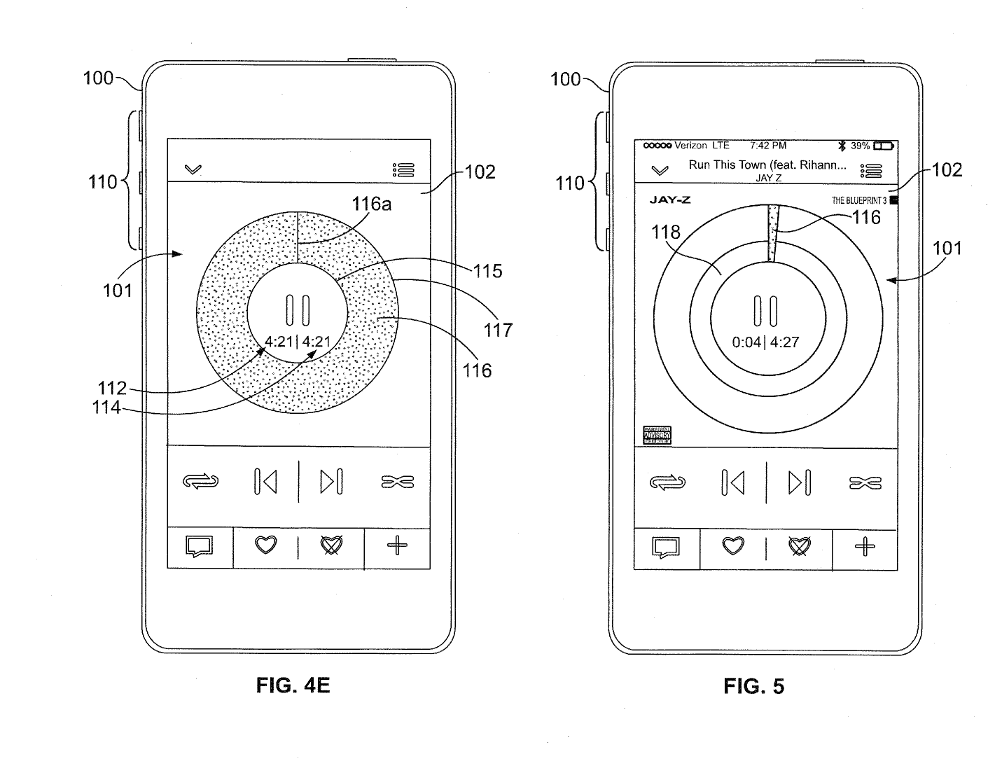

FIGS. 4A, 4B, 4C, 4D, and 4E illustrate exemplary interfaces associated with the execution, facilitation, and implementation of an aspect designed to control the playback of a media object in accordance with embodiments. More specifically, FIGS. 4A-4E illustrate screenshots of exemplary graphical user interfaces associated with a playback control application, or a playback control aspect of a media service application, executing on an electronic device. The exemplary interfaces shown in FIGS. 4A-4E can be displayed on a display of a device used by a user of a media service, for example, the device 1105 and the additional devices 1110 in FIG. 1. The devices can be configured to execute the playback control application, and the interfaces of the application can enable the users to provide input associated with various functionalities. The data associated with the exemplary interfaces can be transmitted to, received from, and/or synchronized with a server, such as the media service server 1115.

It should be appreciated that the users can interface with the playback control application via a user interface of the devices, such as a touchscreen. The exemplary interfaces can be displayed on the touchscreen, which includes contact-sensing technology configured to sense or detect user contact on the touchscreen and to send one or more signals indicating detection of a contact-based input to a processor (e.g., processor 1014 in FIG. 2) executing the playback control application. It should be appreciated that the interfaces of FIGS. 4A-4E are merely exemplary and can comprise other various details, arrangements, and/or selectable options.

FIG. 4A depicts a screenshot of an exemplary graphical user interface 101 for controlling playback of a media object in association with a playback control application executing on an electronic device 100. As illustrated, the graphical user interface 101 can be displayed on a display 102 of the electronic device 100. In embodiments, FIG. 4A depicts a moment in time just after the electronic device 100 has initiated playback of a media object. That is, the interface 101 of can appear on the display 102 upon user selection of a play option (not shown) associated with the media object. The interface 101 can include a plurality of input functions that can be activated by touching, clicking on, or otherwise selecting the appropriate function icon on the screen. In this manner, the interface 101 enables the user to provide inputs associated with various functionalities of the playback control application. In the illustrated embodiment, the interface 101 includes a pause option 104 for pausing the media object, a back option 106 for going back to a beginning of the media object or to a previous media object (for example, a previous song in a play list or an album), and a forward option 108 for skipping ahead to a next media object (for example, a next song in a playlist or an album). In the illustrated embodiment, the device 100 includes volume control input buttons 110 on a side of the device 100 for enabling the user to control the playback volume. In other embodiments, the interface 101 can include volume control options (not shown) for enabling volume control. In embodiments, the interface 101 can further include a plurality of playback indicators that enable the users to provide inputs associated with playback control and display information related to the playback controls, as described herein. For example, the playback indicators can include a circular progress bar 116, a download progress bar 118, and/or a volume control bar 140, as shown in FIG. 4B-4E.

Turning to FIGS. 4B, 4C, 4D and 4E illustrate additional screenshots of the exemplary graphical user interface 101 at different points in time during playback of the media object. Specifically, as illustrated, the interface 101 includes a time elapsed display 112 for displaying an amount of time elapsed in the playback of the media object and a total time display 114 for displaying a total amount of playback time for the media object. As shown in FIGS. 4B-4E, the time elapsed display 112 in each screenshot depicts a different amount of elapsed time, namely: one second of playback in FIG. 4B; forty-one seconds of playback in FIG. 4C; three minutes and thirty-one seconds of playback in FIG. 4D; and four minutes and twenty-one seconds of playback in FIG. 4E, which completes the playback. In embodiments, FIGS. 4B-4E can represent a user interface flow associated with the playback control application.

As seen in FIG. 4C, once playback is initiated, the interface 101 includes a circular progress bar 116. In this embodiment, the circular progress bar 116 includes an outer boundary 116a, an inner boundary 116b, and a first width 116c disposed between the outer boundary 116a and the inner boundary 116b. In the illustrated embodiment, this first width 116c of the circular progress bar 116 extends radially in a first direction and ends at a moving end 116d. The moving end 116d radially moves around the circular progress bar 116 in accordance with the playback progress of the media object between a starting position shown in FIG. 4B and an ending position shown in FIG. 4E. Specifically, in the illustrated embodiment, the circular progress bar 116 extends radially in a clockwise direction as the playback of the media object progresses. As the moving end 116d moves through the circular progress bar 116, the interface 101 graphically fills or shades the path of the moving end 116d within the bar 116, for example, between the starting position and a current position of the moving end 116d. In this manner, the amount of shading or fill displayed in the circular progress bar 116 can represent, or correspond to, the amount of playback time elapsed (for example, as displayed in the elapsed time display 112).

In the illustrated embodiment, the total playback time for the media object is four minutes and twenty-one seconds, as indicated by the total time display 114. In FIG. 4B, the circular progress bar 116 appears to be a vertical line. This is because the media object has only played one second out of the four minutes and twenty-one seconds of total play time. In this embodiment, the circular progress bar 116 has only extended slightly in a clockwise radial direction to indicate that playback has initiated, but almost no time has elapsed, and therefore, playback has only slightly progressed. In FIG. 4C, the circular progress bar 116 is extended further out to represent forty-one seconds of the total playback time having elapsed. In FIG. 4D, three minutes and thirty-one seconds have elapsed, and the circular progress bar 116 has almost extended to complete a full circle. In FIG. 4E, the time elapsed is four minutes and twenty-one seconds, which is the total time of the media object. As such, the circular progress bar 116 has fully and radially extended to form a full circle having a first width 116c. That is, in FIG. 4E, the circular progress bar 116 appears as a circular tube that initiates at the starting position, and as the moving end 116d radially progresses with the playback, fills the bar 116 until ultimately forming a complete circle. As shown in FIG. 4E, once playback is complete, the circular progress bar 116 can appear as a doughnut including two co-centric circles: an inner circle 115 and an outer circle 117. In embodiments, the inner boundary 116b of the circular progress bar 116 can be a first distance from a center of the inner circle 115. For example, the first distance can be a radius of the inner circle 115 Likewise, the outer boundary 116a of the circular progress bar 116 can be a second distance from a center of the outer circle 117. For example, the second distance can be a radius of the outer circle 117.

Thus, it should be appreciated that as the playback of the media object progresses, the interface 101 radially fills the width 116c of the circular progress bar 116 to graphically depict a playback progress for the media object. Further, in this embodiment, the portion of the circular progress bar 116 that is filled in or shaded is proportional to the amount of time that has elapsed for the playback of the media object. As a result, the circular progress bar 116 can graphically depicts the progress of the playback of the media object. In embodiments, the entire circumference of the outer circle 117, as shown in FIG. 4E, represents the total playback time of the media object. As such, playback progress of the song is graphically displayed relative to the total circumference. For example, when half of the circle is formed, the circular progress bar 116 is a half circle. Thus, an arc length of the circular progress bar 116 corresponds to the amount time elapsed relative to the total playback time.

In various alternative embodiments of the present disclosure, when playback is initiated, the electronic device 100 automatically downloads the media object to a memory of the electronic device 100 (for example, a cache memory or a hard drive). As illustrated in FIGS. 4B-4D, during the download, the interface 101 can include a circular download indicator bar 118 to depict a download progress of the media object. In embodiments, the interface 101 displays the download indicator bar 118 has having an overall circular shape, like the circular progress bar 116, and having an outer boundary 118a, an inner boundary 118b, and a width 118c disposed between the inner boundary 118b and the outer boundary 118a. The width 118c of the download indicator bar 118 is a second width different from the first width 116c of the circular progress bar 116. In another embodiment, the width 118c can be equal to or greater than the first width 116c. The width 118c of the download indicator bar 118 extends radially in one direction and can be filled or shaded relative to the playback progress of the media object. More specifically, in this example embodiment, and as illustrated in FIGS. 4B, 4C, and 4D, the download indicator bar 118 extends radially in a clockwise direction as the playback of the media object progresses.

As illustrated in FIG. 4C, the width 118c of the download indicator bar 118 can be less than the circular progress bar width 116c. In this embodiment, the download progress bar 118 and the circular progress bar 116 share the same inner boundary 116b and 118b. Thus, in this embodiment, the interface 101 displays the download indicator bar 118 within the width 116c of the circular progress bar 116. In another embodiment, the outer boundary 118a of the download progress bar 118 can be shared with the inner boundary 116b of the circular progress bar 116. It should be appreciated that in alternative embodiments, the width 118c of the download indicator bar 118 can be equal to or greater than the width 116c of the circular progress bar 116. It also should be appreciated that in alternative embodiments, the download progress bar 118 and the circular progress bar 118 do not share the same inner boundary.

As illustrated in FIGS. 4B, 4C, and 4D, the download indicator bar 118 extends radially in a clockwise direction. As more time passes, the download progress bar 118 extends further, radially, indicating that the download of the media object is progressing. In FIG. 4B, for example, the download progress bar 118 is only partially extended, whereas in FIG. 4C, the download indicator bar 118 has almost extended to a half circle. In FIG. 4D, the download indicator bar 118 has extended to a full circle, thereby indicating that the download is complete, while the media object is still playing. As illustrated, the download indicator bar 118 appears as a circular tube that initiates at a starting position and has a moving end 118d that radially progresses around the bar 118, as the download progresses, until ultimately reaching an ending position and thereby, forming a complete circle. Like the circular progress bar 116, once download is complete, the download indicator bar 118 can appear as two co-centric circles: an inner circle 121 and an outer circle 119. In embodiments, the inner boundary 118b of the download indicator bar 118b can be a first distance from a center of the inner circle 121. For example, the first distance can be a radius of the inner circle 121. And the outer boundary 118a can be a second distance from a center of the outer circle 119. For example, the second distance can be a radius of the outer circle 119.

Thus, it should be appreciated that as the download of the media object to a memory device on the electronic device 100 progresses, the interface 101 radially fills the width 118c of the download indicator bar 118 to graphically depict the download progress for the media object.

As such, the download indicator bar 118 graphically depicts the progress of the download of the media object. Further, it should be appreciated that the rate at which the download indicator bar 118 extends is not proportional to the rate at which the circular progress bar 116 extends. That is, the filling of the circular progress bar 116 is proportional to the time elapsed for the playback of the media object and therefore, the time elapsed for the playback of the media object is related to the length of the circular progress bar 116. The download indicator bar 118, on the other hand, is not so related to the time elapsed for the playback of the media object and can be filled completely independently of the circular progress bar 116. For example, even if playback of the media object is paused, the download indicator bar 118 can continue to fill if the downloading of the media object continues to progress.

It should be appreciated that in this embodiment, the electronic device 100 automatically downloads the media object while continuing the playback of the media object and continuing to radially fill the width of the circular progress bar 116. Thus, in this embodiment, the interface 101 fills both the circular progress bar 116 and the download indicator bar 118 simultaneously to graphically depict the playback progress and the download progress. In certain alternative embodiments, the interface 101 can show one of the circular progress bar 116 or the download indicator bar 118 in separate display screens.

In embodiments, if the media object has already been completely downloaded to a memory of the electronic device 100, the interface 101 displays a filled or completely shaded circular download indicator bar 118, as indicated in FIG. 4D and shown in FIG. 5. For example, once the electronic device 100 downloads a media object to a memory in the electronic device 100 during an initial playback, for one or more subsequent playbacks of the media object, the electronic device 100 retrieves the downloaded media object from the local memory, rather than downloading the media object again, and displays a completely filled download indicator bar 118 upon initiating playback of the media object, as indicated by block 2014 in FIG. 3. This is illustrated in the screenshot depicted in FIG. 5. Specifically, in the illustrated embodiment, the interface 101 displays the circular progress bar 116 as being barely extended, for example, to represent that only four seconds of playback have elapsed. However, in this example, the download indicator bar 118 has completely extended to form a full circle because the media object has already been downloaded to a memory within the device 100. Thus, the full circle of the download indicator bar 118 represents a completed download. In another embodiment, the download indicator bar 118 is not presented if a downloaded media object is already downloaded to a local memory.

Various alternative embodiments of the present disclosure include receiving playback adjustments to control the playback of the media object. More specifically, as described above with reference to FIG. 3, the method 2000 of the present disclosure includes initiating playback of the media object 2002, displaying the circular progress bar 2002, and radially filling the width of the circular progress bar to graphically depict a playback progress for the media object 2016. In certain embodiment, the method 2000 also includes receiving a playback adjustment, as indicated by diamond 2018. Playback adjustments include, but are not limited to, rewinding the playback, fast-forwarding the playback, and pausing the playback of the media object. If the electronic device does not receive a playback adjustment, the method 2000 continues radially filling the width of the circular progress bar to graphically depict a playback progress for the media object. If the electronic device receives a playback adjustment, the method 2000 includes adjusting the display of the circular progress bar accordingly, as indicated by block 2020.

In various embodiments of the present disclosure, a user can adjust the playback by selecting or interacting with one or more of the playback indicators by tapping, touching, and/or dragging the playback indicator with a finger, for example, if the user interface is a touchscreen; by clicking and/or dragging on the playback indicator with a pointer, for example, if the user interface is a mouse; or by using any other input means. The interface and/or the media service application can be configured to recognize certain gestures or inputs and to associate a predetermined result with each gesture or input. The gestures and inputs can include, for example, a single tap or touch, a single click, a double tap or touch, a double click, a long tap or touch, a long click, a short tap or touch, a short click, a right click, a left click, a multi-touch pinch, a multi-touch stretch, a multi-touch swipe, a single-touch swipe, a dragging, sliding, or other moving input, etc. The predetermined results can include, for example, a size expansion or increase of the selected playback indicator or a size reduction or decrease of the selected playback indicators.

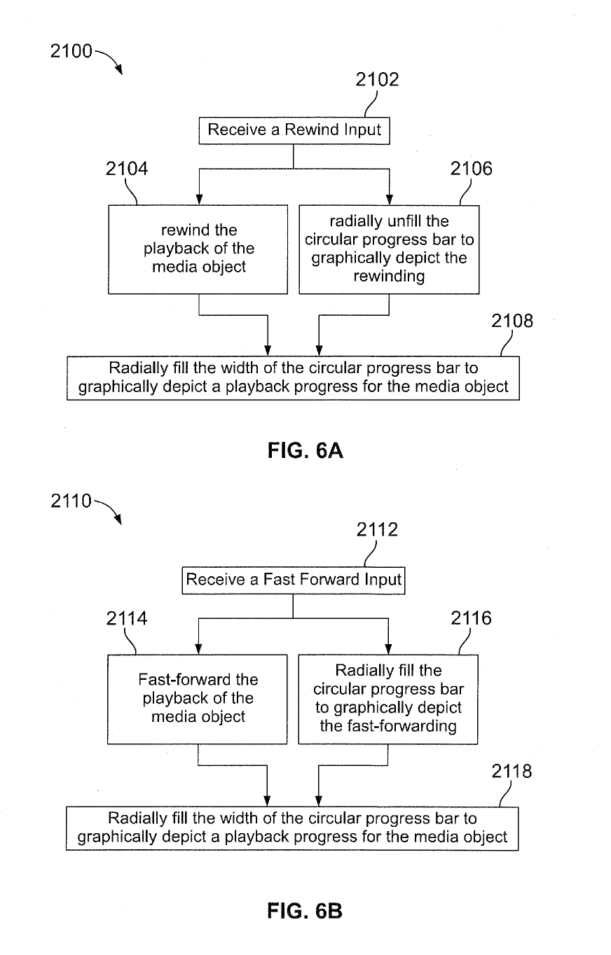

Referring now to FIGS. 6A and 6B, various alternative embodiments of the process or method of operating an electronic device of the present disclosure including a playback adjustment are generally illustrated and indicated by numerals 2100 and 2110. It should be appreciated that the functionalities of the methods 2100 and 2110 can be implemented with the electronic device executing an application and interfacing with a remote server, such as the media service server 1115. In various embodiments, the application can be the playback control application or a portion thereof. In some embodiments, the application can be a computer program stored on a non-transitory computer readable medium that is executable by a processor of the device. Further, according to embodiments, the electronic device includes a display and a user interface (such as a touchscreen), and a processor (such as the processor 1014) communicatively coupled to the display and the user interface.

In various embodiments, methods 2100 and 2110 are represented by a set of instructions stored in one or more memories and executed by one or more processors. As with the methods described with references to the flow charts discussed above, although methods 2100 and 2110 are described with reference to the flow charts shown in FIGS. 6A and 6B, it should be appreciated that many other processes of performing the acts associated with these illustrated methods can be employed. For example, the order of certain of the illustrated blocks and/or diamonds can be changed, certain of the illustrated blocks and/or diamonds can be optional, and/or certain of the illustrated blocks and/or diamonds can not be employed.

Referring to FIG. 6A, in one example embodiment, the method 2100 includes receiving, via a user interface of the electronic device, a rewind input during the playback of the media object, as indicated by block 2102. The electronic device can receive, via the user interface, an input in association with the playback where the input indicates that the user would like to rewind the playback. In some embodiments, the input can be a contact-based input detected by the touchscreen of the electronic device or a different type of gesture. For example, in some embodiments, the input is to drag an icon or a portion of an icon in a certain direction or for a duration of time, or a combination thereof. In some embodiments, the input can be received in association with the multiple icons. It should be appreciated that in various embodiments of the present disclosure, the electronic device receives the rewind input in a plurality of ways, for example, by touching and dragging a progress bar indicator or touching and holding an adjustment indicator, or using a mouse or a keyboard, or any other input means as described above.

Once the electronic device receives a rewind input, the method 2100 includes simultaneously rewinding the playback of the media object and radially un-filling a circular progress bar on the display of the electronic device to graphically depict the rewinding, as indicated by blocks 2104 and 2106. Once the rewinding is completed, the method 2100 includes continuing to radially fill the width of the circular progress bar to graphically depict a playback progress for the media object as indicated by block 2108.

Referring to FIG. 6B, the method 2110 include receiving, via a user interface of the electronic device, a fast-forward input during playback of the media object, as indicated by block 2112. As described above with respect to the rewind input in method 2100, the electronic device can receive, via the user interface, an input in association with fast-forwarding the playback in a plurality of ways. Once the electronic device receives a fast-forward input, the method 2110 includes simultaneously fast-forwarding the playback of the media object and radially filling the circular progress bar to graphically depict the fast-forwarding, as indicated by blocks 2114 and 2116. Once the fast-forwarding is completed, the method 2100 includes continuing to radially fill the width of the circular progress bar to graphically depict a playback progress for the media object as indicated by block 2118.

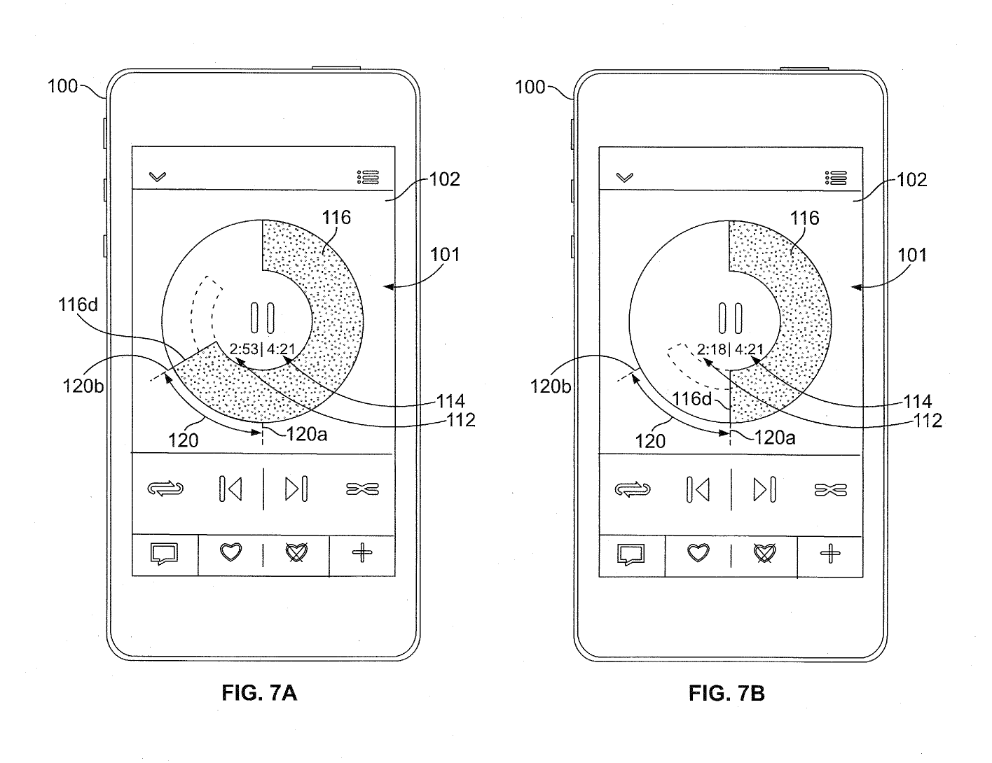

FIGS. 7A and 7B depict screenshots of the exemplary graphically user interface 101 of FIGS. 4A-4E showing a media playback adjustment. In FIG. 7 A, the elapsed time display 112 depicts the playback progress at two minutes and fifty-three seconds, while in FIG. 7B, the elapsed time display 112 depicts the playback progress at two minutes and eighteen seconds. The circular progress bar 116 is radially extended to graphically depict the playback progress in each of the exemplary screenshots. In embodiments, the circular progress bar 116 radially extends in a clockwise direction.

According to embodiments, the interface 101 enables the user to adjust the playback progress, (for example, by rewinding and fast-forwarding the playback) in a plurality of ways. In some embodiments, the interface 101 enables the user to rewind and fast-forward the playback by allowing the user to interact with the circular progress bar 116. As described above, the moving end 116d of the circular progress bar 116 is the end of the progress bar that is being radially extended to depict the playback progress. In certain alternative embodiments, the interface 101 enables the user to touch the moving end 116d of the circular progress bar 116 and drag the moving end 116d forward or backward to adjust playback. For example, if the user drags the moving end 116d of the circular progress bar 116 in a direction opposite from the first direction of the circular progress bar 116 (for example, in a counter-clockwise direction), the playback of the media object is rewinded. Likewise, if the user drags the moving end 116d of the circular progress bar 116 along the first direction of the circular progress bar 116 (for example, in a clockwise direction), the playback of the media object is fast-forwarded.

In this example embodiment, to rewind the playback of the media object from two minutes and fifty-three seconds, as shown in FIG. 7A, to two minutes and eighteen seconds, as shown in FIG. 7B, the interface 101 enables the user to drag the moving end 116d of the circular progress bar 116 a distance 120 between a first point 120b and a second point 120a along the circumference of the circular progress bar 116. As shown in FIG. 7A, the distance 120 forms an arc along the circular progress bar 116. In other words, the distance 120 represents the distance the user drags the circular progress bar 116 in a counter-clockwise direction and corresponds to the amount of time that playback is rewinded. Similarly, to fast-forward the media object, the interface 101 enables the user to drag the moving end 116d of the circular progress bar 116 forward, in the same clockwise direction of the circular progress bar 116. For example, to fast-forward the media object from the two minutes and eighteen seconds of playback shown in FIG.

7B to the two minutes and fifty-three seconds of playback shown in FIG. 7 A, the user can drag the moving end 116d of the circular progress bar 116 in a clockwise direction from 120a to 120b.

Thus, in the example embodiment, the interface 101 enables the user to drag the moving end 116d of the circular progress bar 116, thus allowing the user to manually adjust the display of the circular progress bar 116 to reflect a desired playback progress.

In certain alternative embodiments, the electronic device 100 adjusts the playback of the media object and the display of the circular progress bar 116 simultaneously, but without requiring the user to manually drag the circular progress bar 116 or otherwise enter an input through the graphical user interface 101. For example, in various alternative embodiments, the electronic device can include physical playback adjustment buttons or other hardware for enabling the user to adjust the playback using the electronic device, rather than a touchscreen. In one such example embodiment, the electronic device will adjust the circular progress bar display to reflect the change in playback progress entered by the user on the physical playback adjustment buttons, while simultaneously adjusting the actually playback of the media object. More specifically, the electronic device will rewind (or fast-forward) the playback of the media object and, at the same time, will radially un-fill (or fill) the width of the circular progress bar to graphically depict the rewinding (or fast-forwarding). Thus, the electronic device can simultaneously adjust the media playback and the circular progress bar display to reflect the change in the media playback progress, even if the adjustment input is not received through the interface 101.

In one example alternative embodiment, the electronic device 100 enables the user to adjust playback using additional or alternative adjustment indicators. More specifically, in this example alternative embodiment, the electronic device 100 displays additional or alternative indicators for rewinding or fast-forwarding the playback (not shown). In this example embodiment, the additional indicators are icons on a touchscreen interface, and the user can touch and/or hold the indicators for a duration of time in order to indicate a desired amount of rewinding or fast-forwarding. In this example embodiment, the length of time that the player holds the indicators corresponds to the amount of time the electronic device 100 will adjust the playback and the circular progress bar 116. In certain alternative embodiments, the electronic device 100 begins rewinding (or fast-forwarding) upon a first touch of the rewind (or fast-forward) indicator and stops the rewinding (or fast-forwarding) upon a second touch of the rewind (or fast-forward) indicator. In a variation of this alternative embodiment, the electronic device 100 radially un-fills (or fills) the width of the circular progress bar simultaneously with the rewinding (or fast-forwarding) of the playback. It should be appreciated that in certain alternative embodiments, the electronic device 100 does not simultaneously adjust the media playback and the circular progress bar display.

In certain alternative embodiments, the electronic device 100 displays a first circular progress bar before the adjustment to the circular progress bar is initiated and a second different circular progress bar after the adjustment to the circular progress bar is completed, so that the moving end 116d of the circular progress bar 116 is not moving as the playback is being adjusted.

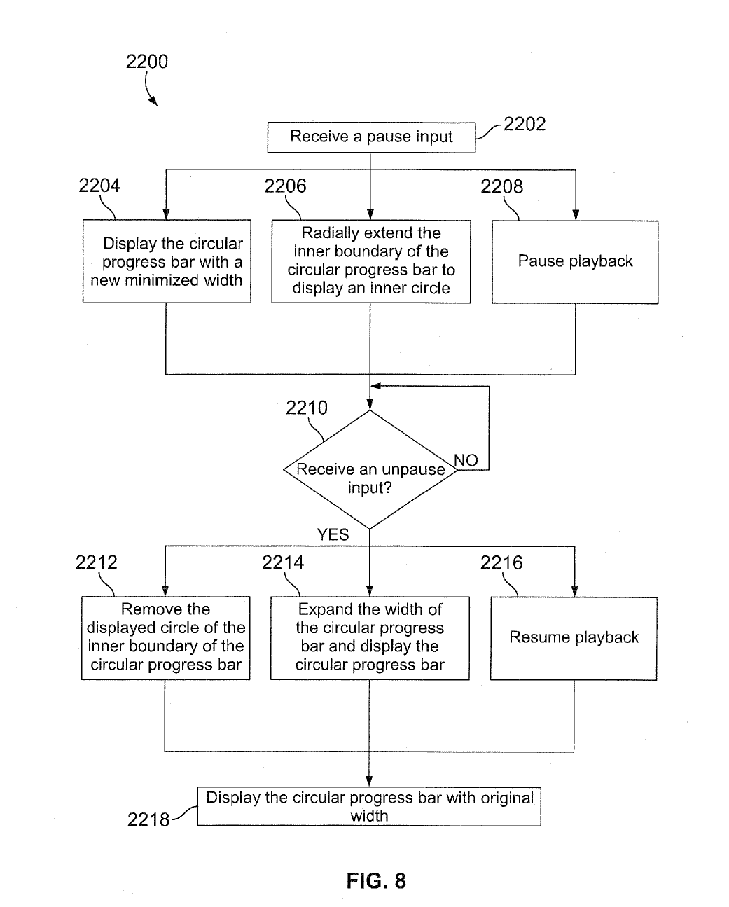

Referring now to FIG. 8, various alternative embodiments of the process or method of operating an electronic device of the present disclosure including another playback adjustment, pausing and resuming playback, is generally illustrated and indicated by numeral 2200. It should be appreciated that the functionalities of the method 2200 can be implemented with the electronic device executing an application and interfacing with a remote server, such as the media service server 1115. In various embodiments, the application can be the playback control application or a portion thereof. In some embodiments, the application can be a computer program stored on a non-transitory computer readable medium that is executable by a processor of the device. Further, according to embodiments, the electronic device includes a display and a user interface, and a processor (such as the processor 1014) communicatively coupled to the display and the user interface.

In various embodiments, method 2200 is represented by a set of instructions stored in one or more memories and executed by one or more processors. As with the methods described with references to the flow charts discussed above, although method 2200 is described with reference to the flow chart shown in FIG. 8, it should be appreciated that many other processes of performing the acts associated with these illustrated methods can be employed. For example, the order of certain of the illustrated blocks and/or diamonds can be changed, certain of the illustrated blocks and/or diamonds can be optional, and/or certain of the illustrated blocks and/or diamonds can not be employed.

FIG. 8 illustrates a flowchart of one example embodiment, wherein the method 2200 includes receiving, via a user interface of the electronic device, a pause input during the playback of the media object, as indicated by block 2202. The electronic device can receive, via the user interface, an input in association with pausing the playback where the input indicates that the user would like to pause the playback of a media object, or resume the playback of a paused playback. In some embodiments, the input can be a contact-based input detected by the touchscreen of the electronic device or a different type of gesture. For example, the input can be a double-tap/touch gesture, or a single-tap/touch gesture. As another example, the input can be a short tap or a long tap. In some embodiments, the input is to touch and hold (e.g., a long hold) an icon for a duration of time. In some embodiments, the input can be received in association with the multiple icons. In another embodiment, the input can be automatic when playback progress equals download progress.

It should be appreciated that in various embodiments of the present disclosure, the electronic device receives the pause input in a plurality of ways such as, for example, by touching the pause indicator, or using a mouse or a keyboard, or any other input means as described above. Once the electronic device receives a pause input, the method 2200 includes: displaying the circular progress bar with a new minimized width, displaying an inner circle by radially extending the inner boundary of the circular progress bar, and pausing the playback of the media object as indicated by blocks 2204, 2206, and 2208, respectively. It should be appreciated that in certain embodiments, the method 2200 includes performing all three of these steps simultaneously. The method 2200 then determines whether the electronic device receives an un-pause input as indicated by diamond 2210. If the electronic device receives a un-pause input, the method 2200 includes simultaneously expanding the width of the circular progress bar to the previous, pre-pause width and displaying the expanded circular progress bar, removing the displayed circle formed by extending the inner boundary of the circular progress bar, and un-pausing the playback of the media object, as indicated by blocks 2214, 2212, and 2216, respectively. The method 2200 then includes displaying the circular progress bar at its previous width as indicated by block 2218.

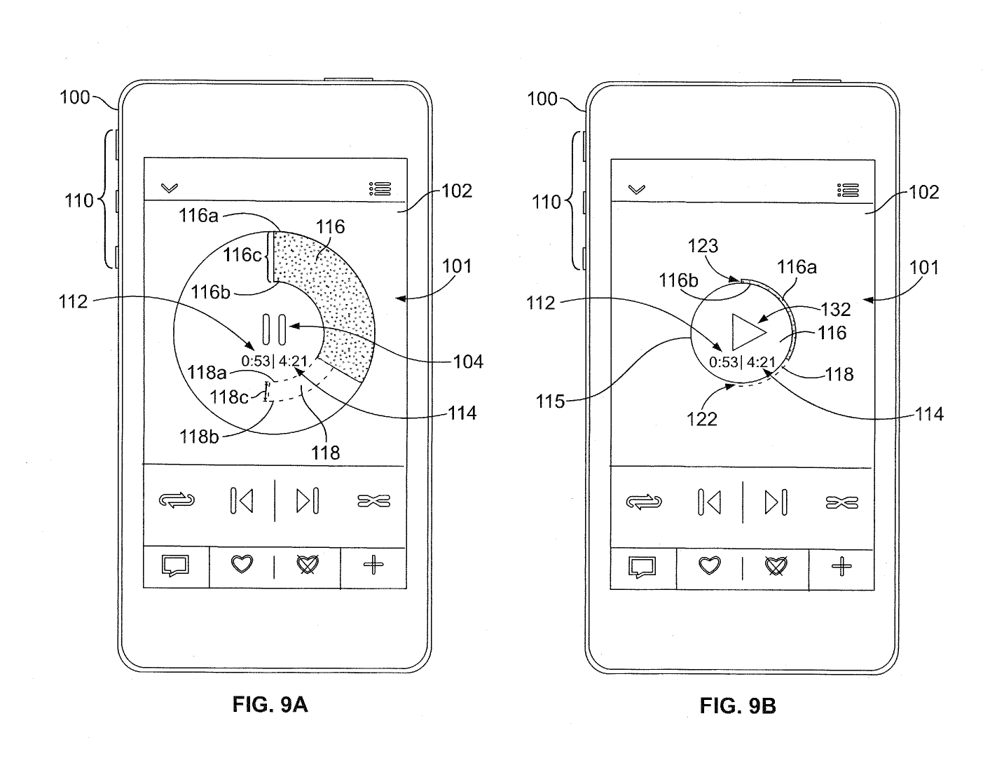

FIGS. 9A and 9B illustrate screenshots of the graphical user interface 101 according to an example embodiment showing receipt of an input to pause the media object. Specifically, FIG. 9A illustrates a screenshot of the interface 101 before the electronic device 100 receives a pause input. In this example embodiment, during playback of a media object, the interface 101 includes a user-selectable option 104 for pausing the playback of the media object. FIG. 9B illustrates a screenshot of the interface 101 after receipt of a pause input, for example, via the pause option 104.

As illustrated by the time elapsed display 112 in FIGS. 9A and 9B, the playback for this example embodiment is paused at fifty-three seconds. As illustrated by FIG. 9B, once the interface 101 receives the pause input, the width 116c of the circular progress bar 116 shrinks down to a new minimized width 122. The electronic device 100 can shrink the width 116c of the circular progress bar 116 by moving the outer boundary 116a of the circular progress bar 116 towards the inner boundary 116b of the circular progress bar 116. Thus, in this example embodiment, the inner boundary 116b of the circular progress bar 116 remains unchanged. Additionally, the interface 101 displays the inner circle 115 of the circular progress bar 116 by radially extending the inner boundary 116b of the circular progress bar 116. In certain embodiments, the interface 101 simultaneously displays the inner circle 115 and the minimized circular progress bar 116. In doing so, the original, pre-pause width 116c appears to shrink down to the minimized width 122. It should be appreciated that in this example embodiment, when the interface 101 receives a pause input the electronic device 100 pauses the playback of the media object, shrinks the circular progress bar 116 from the width 116c to a new minimized width 122, and displays the inner circle 115 simultaneously. In certain alternative embodiments, the electronic device 100 does not simultaneously adjust the display and the playback.

In this example embodiment, after receiving a pause input, the interface 101 enables the user to un-pause or resume the media object playback. More specifically, as shown in FIG. 9B, after pausing the playback of the media object, the interface 101 displays a play option 132 in place of the previous pause option 104. This is to enable the user to un-pause, or resume playback of the media object. In certain alternative embodiments, the electronic device 100 does not replace the pause option 104 with the play option 132, but rather enables the user to un-pause or resume playback by touching the pause option 104 a second time.

If the electronic device 100 receives an un-pause input, the electronic device un-pauses playback of the media object, expands the minimized width 122 of the circular progress bar 116 to the original width 116c of the circular progress bar 116, and removes the display of the inner circle 115. That is, the interface 101 returns to the display shown in FIG. 9A. In doing so, the inner circle 115 and minimized width 122, as shown in FIG. 9B, appear to pop out to the original, pre-pause circular progress bar 116 having the width 116c. It should be appreciated that in this example embodiment, when the interface 101 receives an un-pause input the electronic device 100 resumes the playback of the media object, expands the minimized width 122 of the circular progress bar 116 to the original width 116c of the circular progress bar 116, and removes the the inner circle 115 simultaneously. In certain alternative embodiments, the electronic device 100 does not simultaneously adjust the display and the playback.

In certain alternative embodiments, the interface 101 also includes the download progress indicator 118. In certain alternative embodiments, the width 118c of the download progress bar 118 also shrinks to a new minimized width 123. In certain variations of this alternative embodiment, the minimized width 123 of the download indicator bar 118 is equal to the minimized width 122 of the circular progress bar 116. In other embodiments the minimized width 123 of the download indicator bar 118 is less than the minimized width 122 of the circular progress bar 116.

It should be appreciated that in the embodiment described above, the electronic device 100 altered the interface 101 more substantially than in the embodiments described above with respect to rewinding and fast-forwarding. More specifically, in the embodiment described above with respect to rewinding and fast-forwarding, the electronic device 100 did not alter the width 116c of the circular progress bar. Instead, only the length of the circular progress bar 116 was altered to reflect the changes in playback time. In the embodiment described herein with respect to pausing the playback, the electronic device 100 shrinks the circular progress bar 116 (and in some embodiments, the download progress bar 118) and displays the inner circle 115 with the playback indicators having a minimized width (e.g., widths 122 and/or 123). In certain of these embodiments, the electronic device 100 resumes playback by popping the circular progress bar 116 and download progress bar 118 back out such that the playback indicators retain their original widths 116c and/or 118c.

It should be appreciated that the different alterations to the display are not limited to pausing the playback. The example embodiments described with respect to rewinding, fast forwarding and pausing are exemplary illustrations and are not intended to be limited to the specific aspect of controlling the playback. For example, in certain alternative embodiments, the electronic device 100 shrinks the bar 116 when enabling the user to rewind or fast-forward the playback. In other alternative embodiments, the electronic device 100 enables the user to pause the playback while maintaining the original width of the circular progress bar 116. In another alternative embodiment, instead of shrinking the circular progress bar 116, the electronic device 100 fades the appearance of the circular progress bar 116.

It should be appreciated that the flow charts and figures used to describe examples of playback adjustments are exemplary and not intended to be limiting. The flow charts and figures are intended to be illustrations of various examples.

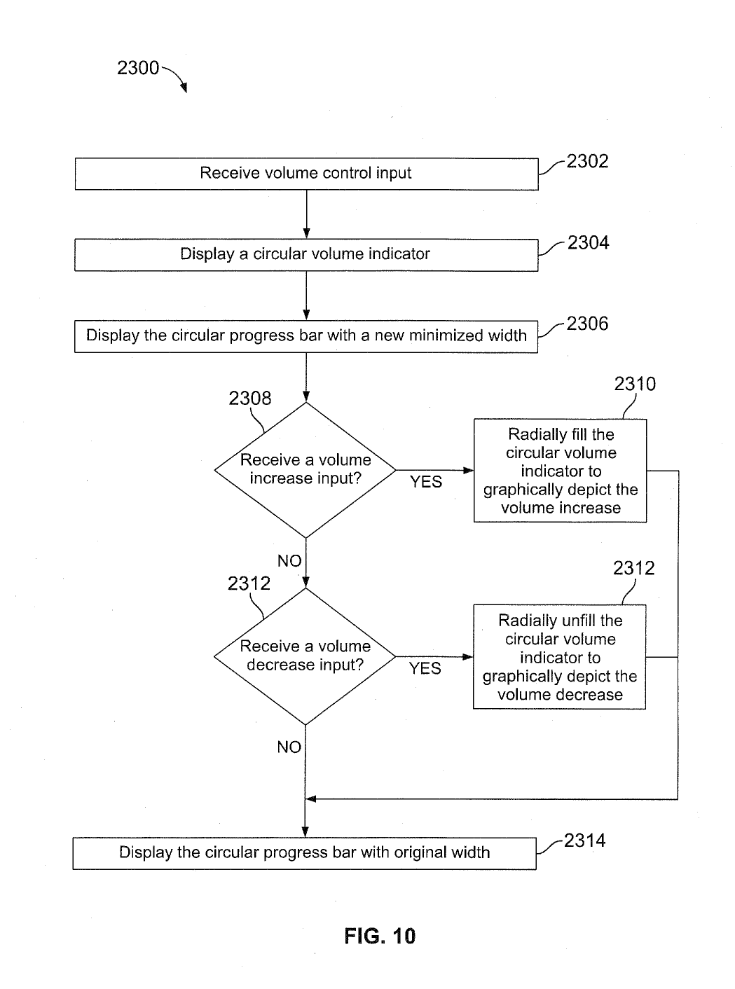

Referring now to FIG. 10, various embodiments of the process or method of operating an electronic device of the present disclosure including volume control of the media object playback is generally illustrated and indicated by numeral 2300. It should be appreciated that the functionalities of the method 2300 can be implemented with the electronic device executing an application and interfacing with a remote server, such as the media service server 1115. In various embodiments, the application can be the playback control application or a portion thereof. In some embodiments, the application can be a computer program stored on a non-transitory computer readable medium that is executable by a processor of the device. Further, according to embodiments, the electronic device includes a display and a user interface, and a processor (such as the processor 1014) communicatively coupled to the display and the user interface.

In various embodiments, method 2300 is represented by a set of instructions stored in one or more memories and executed by one or more processors. As with the methods described with references to the flow charts discussed above, although method 2300 is described with reference to the flow chart shown in FIG. 10, it should be appreciated that many other processes of performing the acts associated with these illustrated methods can be employed. For example, the order of certain of the illustrated blocks and/or diamonds can be changed, certain of the illustrated blocks and/or diamonds can be optional, and/or certain of the illustrated blocks and/or diamonds can not be employed.

FIG. 10 depicts one example embodiment, wherein the method 2300 includes receiving a volume control input through the user interface of the electronic device as indicated by block 2302. The electronic device can receive, via the user interface, an input in association with the volume of the playback where the input indicates that the user would like to view the volume level, mute/unmute the volume level, increase the volume level, or decrease the volume level. In some embodiments, the input is received via physical volume control buttons included on the electronic device. In some embodiments, the input can be a contact-based input detected by the touchscreen of the electronic device or a different type of gesture. For example, the input can be a double-tap/touch gesture, or a single-tap/touch gesture. As another example, the input can be a short tap or a long tap. In some embodiments, the input is to drag an icon or a portion of an icon in a certain direction or for a duration of time, or a combination thereof. In some embodiments, the input can be received in association with the multiple icons.

The method 2300 includes displaying a circular volume indicator having a volume indicator width as indicated by 2304. It should be appreciated that in this embodiment, the electronic device does not display the circular volume indicator prior to receiving the volume control input. Once the electronic device receives a volume control input, the method 2300 includes displaying the circular progress bar with a new minimized width as indicated by block 2306. It should be appreciated that in certain embodiments, the circular volume indicator expands out as the circular progress bar shrinks down. Thus, the display appears to show the circular volume indicators popping out as the circular progress bar shrinks.

The method 2300 then includes determining whether the electronic device received a volume increase input as indicated by diamond 2308. If the electronic device includes receiving a volume increase input, the method 2300 includes radially filling the circular volume indicator to graphically depict the volume increase. If the electronic device did not receive a volume increase input, the method 2300 includes determining whether the electronic device received a volume decrease input as indicated by diamond 2312. If the electronic device received a volume decrease input, the method 2300 includes radially un-filling the circular volume indicator to graphically depict volume decrease. Once the volume adjustments are completed, the method 2300 includes returning to and displaying the circular progress bar with the original width. It should be appreciated that the volume control inputs include an input to increase volume, decrease volume, mute/unmute volume, or just to display volume. Thus, where the user does not select to increase or decrease the volume, the method includes displaying the volume indicator bar and then returning to the original circular progress bar with its original width. In one embodiment, where the user mutes or unmutes volume, the method can include radially un-filling the volume indicator bar when muted and radially filling the volume indicator bar when unmuted. In another embodiment, where the user mutes or unmutes volume a mute or unmute symbol is displayed and the volume indicator bar displays the current volume level.

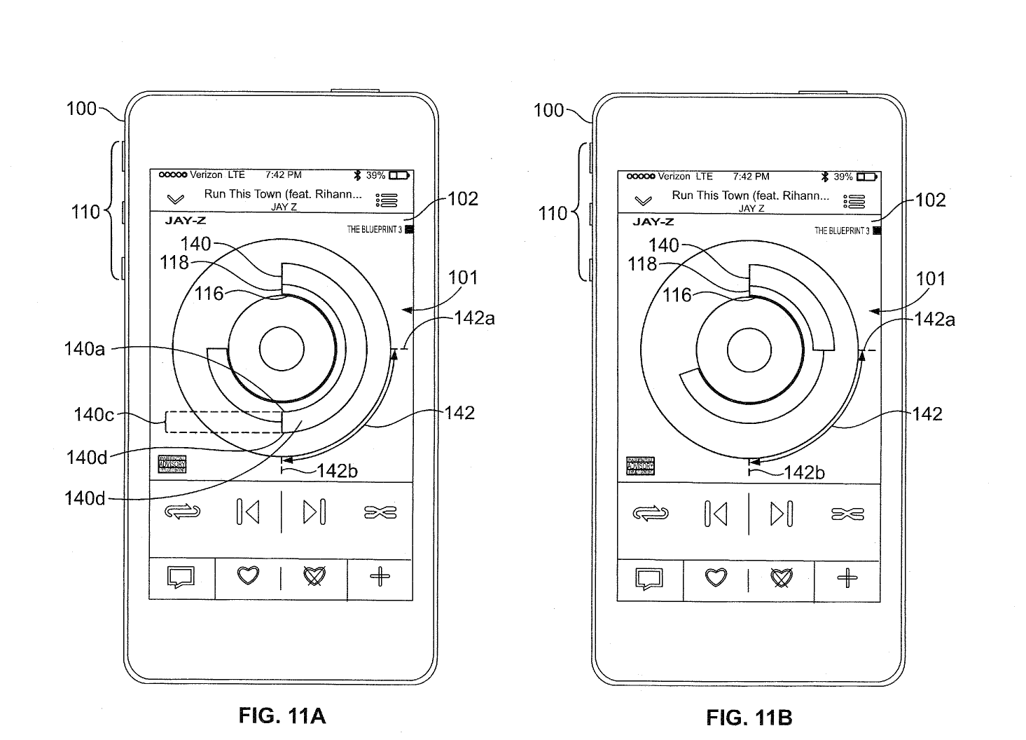

FIGS. 11A and 11B illustrate screenshots of the graphical user interface 101 of the electronic device 100 depicting various stages of volume control. As illustrated in FIG. 11A, the electronic device 100 responds to the volume control input by popping out a display of a circular volume indicator 140. It should be appreciated that in certain embodiments, the circular volume indicator 140 is not displayed until the electronic device 100 receives a volume control input. For example, as illustrated in FIGS. 4A-4E, 5, 7A, 7B, 9A, and 9B, the interface 101 can include a circular progress bar 116, and, in some embodiments, a download progress bar 118, but no volume indicator bar 140. More specifically, a comparison of FIG. 5 and FIG. 11 illustrates that there is no circular volume indicator bar shown in the interface 101 of the electronic device 100 in FIG. 5.

Turning back to FIG. 11A, after receiving the volume control input, the electronic device 100 shrinks the circular progress bar 116 and pops out the circular volume indicator bar 140. The electronic device shrinks the circular progress bar 116 by reducing the width116c disposed between the outer boundary 116a and the inner boundary 116b of the circular progress bar 116. In this embodiment, the electronic device 100 moves the outer boundary 116a towards the inner boundary 116b and leaves the inner boundary 116b unchanged.

The electronic device 100 displays the circular volume indicator 140 with an outer boundary 140b, an inner boundary 140a, and a volume indicator width 140c disposed between the outer boundary 140b and the inner boundary 140a. In this example embodiment, the width 140c of the circular volume indicator 140 is less than the original width 116c of the circular progress bar 116, as indicated by the fact that the outer boundary 140b of the circular volume indicator 140 is the same as the original outer boundary 116a of the circular progress bar 116. Further, the inner boundary 140a of the circular volume indicator 140 is different from the inner boundary 116b of the circular progress bar 116. Thus, the width 140c disposed between the inner boundary 140a of the circular volume indicator 140 and the outer boundary 140b of the circular volume indicator 140 is less than the width 116c of the circular progress bar 116. In certain embodiments, such as this example embodiment, the volume indicator bar 140 is displayed within the original width 116c of the circular progress bar 116. In another embodiment, the width 140c of volume indicator 140 is greater than or equal to original width 116c of the circular progress bar 116.

In embodiments, the circular volume indicator bar 140 includes a moving end 140d that radially extends to graphically depict changes in the volume. It should be appreciated that the interface 101 extends the circular volume indicator 140 by radially filling and un-filling the width 140c of the circular volume indicator 140 to graphically depict the volume change. Thus, the circular volume indicator bar 140 appears as a circular tube that initiates at a starting position and has the moving end 140d radially moving around the bar 140 as the volume increases. The bar 140 forms, or fills in, a complete circle upon reaching a maximum volume setting. Further, the bar 140 disappears, or has zero filling, upon reaching a minimum volume setting. More specifically, at full volume, the circular volume indicator bar 140 appears as two co-centric circles: an inner circle defined by the inner boundary 140a and an outer circle defined by the outer boundary 140b. The inner boundary 140a can be a first distance from a center of inner circle, or a first radius of the inner circle. And the outer boundary 140b can be a second distance from a center of the outer circle, or a second radius of the outer circle.

In various embodiments of the present disclosure, the electronic device 100 enables the user to adjust the volume in a plurality of ways. In some embodiments of the present disclosure, the electronic device 100 enables the user to adjust the volume of the playback by touching and radially dragging the moving end 140d of the circular volume indicator bar 140 in a first direction to increase the volume (for example, clockwise) and in the opposite direction to decrease the volume (for example, counter-clockwise). Thus, in these embodiments, the user manually updates the display of the circular volume indicator bar 140 to reflect the volume change.

In certain alternative embodiments, the electronic device 140 additionally or alternatively enables the user to adjust the volume through volume control inputs separate from the circular volume indicator bar 140, such as the volume control inputs 110 on the device 100. In one example embodiment, the volume control inputs 110 are up and down arrows to indicate increase and decrease of volume. In an example of such an embodiment, the electronic device 100 radially adjusts the circular volume indicator 140 by filling or un-filling the width 140c of the circular volume indicator 140 to reflect the change in volume while adjusting the volume of the playback corresponding to the control inputs 110.

FIGS. 11A and 11B depict two exemplary playback volumes. In embodiments, the electronic device 100 enables the user to decrease the volume of the playback from the volume depicted in FIG. 11A to the volume depicted in FIG. 11B, or conversely, to increase the volume back to that depicted in FIG. 11A. More specifically, in one example embodiment, as illustrated in FIG. 11A, the circular volume indicator 140 is radially extended half way around the circle formed by the outer boundary 140b. The circumference of this outer circle represents the full range of volume for the playback, and the circular volume indicator 140 graphically depicts the current volume level relative to the total possible volume level. For example, in FIG. 11A, the circular volume indicator 140 is a half circle, and thus, the volume level of the playback is half of the total possible volume. In FIG. 11B, the circular volume indicator 140 is about one fourth of a full circle, and thus, one fourth of the total possible volume is being outputted.

In embodiments, the interface 101 enables a user to touch and radially drag the moving end 140d of the circular volume indicator 140 in a first direction to increase the volume of the playback. In this example embodiment, the first direction is clockwise. If, on the other hand, a user wants to decrease the volume of the playback, the interface 101 enables the user to drag the circular volume indicator 140 in a second direction opposite of the first direction, or counter-clockwise, to decrease the volume. Thus, in FIG. 11B, if the user drags the moving end 140d of the circular volume indicator from point 142a to point 142b, the electronic device 100 increases the volume proportionally to reflect the volume level in FIG. 11A. If, in FIG. 11A, the user drags the moving end 140d from 142b to 142a, the electronic device 100 decreases the volume proportionally as shown from FIG. 11B.

In certain alternative embodiments, the interface 101 also includes the download progress indicator 118. In certain alternative embodiments, the width of the download progress bar 118 also shrinks to a minimized width upon receiving a volume input. In other embodiments, the width of the download progress bar 118 remains the same upon receiving a volume input. As illustrated in FIGS. 11A and 11B, the width of the download progress indicator 118 is less than the circular volume indicator width 140c, but greater than the minimized width of the circular progress bar 116. In certain variations of this alternative embodiment, the minimized width of the download indicator bar is the same as the minimized width of the circular progress bar width 116. In certain embodiments, the width 140c of the circular volume indicator 140 is less than the original width of the circular progress bar 116. For example, the combined width of the circular volume indicator 140, the download progress indicator 118, and the minimized circular progress bar 116, as shown in FIG. 11A, is less than the original width 116c of the circular progress bar 116, as shown in FIG. 4C and FIG. 5. In other embodiments the combined width of the circular volume indicator 140, the download progress indicator 118, and the minimized circular progress bar 116, as shown in FIG. 11A, is equal to or greater than the original width 116c of the circular progress bar 116, as shown in FIG. 4C and FIG. 5

It should be appreciated that the above described playback control indicators are non-limiting examples controlling playback of a media object. The examples are to illustrate the different manner in which the electronic device 100 displays the various playback indicators, and how the displays of each indicators are changed with respect to the others.

It should also be appreciated from the above described embodiments that in various embodiments, certain adjustments to the playback, such as rewinding, fast-forwarding can be made using the same playback indicator, for example the circular progress bar 116. In these embodiments, the electronic device 100 enables the user to interact with the circular progress bar 116 to control the playback while maintaining the width and general appearance of the circular progress bar 116. In these embodiments, the interface 101 enables the user to alter the length of the circular progress bar 116. In other alternative embodiments, the electronic device 100 can utilize a more substantial change in the display to indicate a playback control, for example, the pause input, has been received. It should be appreciated from the example embodiment described above, that in certain alternative embodiments, the electronic device 100 can shrink a main display and/or switch to an altered display to show that an input, such as pause, has been received.

It should be appreciated that the above-described manner of displaying the change in playback can be employed for a plurality of playback control options. More specifically, each of the different display embodiments described can be employed for any of a plurality of other control options. Other control options include, but are not limited to, controlling display aspects such as color, brightness, contrast, etc. The embodiments of the present disclosure described above can also be employed for displaying changes to settings on the electronic device 100, for example, date and time, alarm clocks, other sounds on the electronic device 100.

In other alternative embodiments, the electronic device 100 changes the indicators in the display to provide for the popping out, or in, of different indicators. For example, in certain embodiments, the circular volume indicator 140 is not displayed until a volume control input is received by the electronic device. Additionally, when the interface 101 displays the circular volume indicator 140, the interface 101 alters, for example, shrinks, the other indicators on the display (for example, the download progress bar 118).

It should be appreciated that the present disclosure is not limited to the aspects of playback control as they are described above. In addition to the control aspects described here, the present disclosure contemplates the electronic device enables the user to control a plurality of playback control indicators using any combination of the above described displays and indicators. For example, a display indicator for adjusting brightness, color, contrast and other display metrics can be employed in the same manner as for example the circular volume indicator.

It should also be appreciated that in certain alternative embodiments, multiple indicators are displayed simultaneous. In certain alternative embodiments, the interface 101 can display one or more different indicators in one display. For example, in certain of the example embodiments described above, the electronic device 100 displayed the circular progress bar 116 and the download progress indicator 118 in the same display. In certain alternative embodiments, the electronic device 100 can display the circular progress indicator 116, the download progress indicator 118, and the volume control indicator 140 in one display. In other alternative embodiments, the electronic device 100 displays one or more of the same indicators in the same display. For example, in certain embodiments, the electronic device 100 is downloading more than one media object at the same time, and the electronic device 100 displays one or more download progress indicators in the same display.

It should also be appreciated that while the illustrated embodiments depict a solid shading or filling in of the circular progress bar 116, the download progress indicator 118, and/or the circular volume indicator 140, any of a number of other types of fills can be used to indicate a progress of the playback indicators. For example, the playback indicators can be filled with striping, checkerboarding, polka-dots, images, photographs, or zig-zags.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as can be amended during the pendency of this application for patent, and all equivalents thereof, when interpreted in accordance with the breadth to which they are fairly, legally and equitably entitled.

1. A method for controlling playback of a media object on an electronic device, comprising:
initiating a playback of the media object using the electronic device;
rendering, on a display of the electronic device, a circular progress bar having an inner boundary, an outer boundary, and a first width disposed between the inner boundary and the outer boundary; and
during the playback of the media object, radially filling the width of the circular progress bar to graphically depict a playback progress for the media object.

2. The method of claim 1, further comprising:
automatically downloading the media object to a memory of the electronic device if the media object is not currently stored in the memory;
rendering, on the display of the electronic device a circular download indicator within the first width of the circular progress bar, the circular download indicator having a second width less than the first width of the circular progress bar; and
radially filling the second width of the circular download indicator to graphically depict a downloading progress for the media object.

3. The method of claim 2, wherein the circular download indicator having a second width equal to the first width of the circular progress bar.

4. The method of claim 1, further comprising:
while displaying the circular progress bar, receiving a volume control input via a user interface of the electronic device; and
responsive to the volume control input, minimizing the first width to a third width and expanding a circular volume indicator having a fourth width greater than the third width, the circular volume indicator sharing an inner boundary with the outer boundary of the third width.

5. The method of claim 1, further comprising:
receiving, via a user interface of the electronic device, a fast-forward input moving in a first arc along the circular progress bar in a first direction; and
responsive to the fast-forward input, simultaneously:
fast-forwarding the playback of the media object according to a length of the first arc, and
radially filling the width of the circular progress bar along the first arc to graphically depict the fast-forwarding.

6. The method of claim 1, further comprising:
receiving, via a user interface of the electronic device, a rewind input moving in a second arc along the circular progress bar in a second direction; and
responsive to the rewind input, simultaneously:
rewinding the playback of the media object according to a length of the second arc, and
radially un-filling the width of the circular progress bar along the second arc to graphically depict the rewinding.

7. The method of claim 1, wherein a central portion of the circular progress bar includes a user-selectable option for pausing and playing the playback of the media object.

8. The method of claim 7, further comprising:
receiving, via a user interface of the electronic device, a pause input; and
responsive to the pause input, simultaneously:
pausing the playback of the media object,
displaying an inner circle by extending the inner boundary of the circular progress bar, and
minimizing the first width to a fifth width where the fifth width is less than the first width.

9. The method of claim 8, further comprising:
receiving, via a user interface of the electronic device, a play input; and
responsive to the play input, simultaneously:
playing the playback of the media object,
removing the displayed inner circle by unextending the inner boundary of the circular progress bar, and
expanding the fifth width to be equal to the first width.

10. A system comprising:
a music service server;
a network; and
a electronic device communicatively coupled to the music service server through the network, the electronic device having a music interface associated with a music service to enable a user to control playback of a media object on the electronic device including:
initiate, from the music interface, playback of the media object;
render, on a display of the electronic device, a circular progress bar having an inner boundary, an outer boundary, and a first width disposed between the inner boundary and the outer boundary; and
fill radially, on the display of the electronic device, the width of the circular progress bar to graphically depict a playback progress for the media object.

11. The system of claim 10, further comprising:
automatic download of the media object to a memory of the electronic device if the media object is not currently stored in the memory;
render, on the display of the electronic device, a circular download indicator within the first width of the circular progress bar, the circular download indicator having a second width less than the first width of the circular progress bar; and
fill radially, on the display of the electronic device, the second width of the circular download indicator to graphically depict a downloading progress for the media object.

12. The system of claim 11, wherein the circular download indicator having a second width equal to the first width of the circular progress bar.

13. The system of claim 10, further comprising:
receive, during display of the circular progress bar, a volume control input via a user interface of the electronic device; and
minimize, in response to the volume control input, the first width to a third width and expanding a circular volume indicator having a fourth width greater than the third width, the circular volume indicator sharing an inner boundary with the outer boundary of the third width.

14. The system of claim 10, further comprising:
receive, via a user interface of the electronic device, a fast-forward input moving in a first arc along the circular progress bar in a first direction; and
fast-forward, in response to the fast-forward input, the playback of the media object according to a length of the first arc, and
fill radially, simultaneously with the fast-forward, the width of the circular progress bar along the first arc to graphically depict the fast-forwarding.

15. The system of claim 10, further comprising:
receive, via a user interface of the electronic device, a rewind input moving in a second arc along the circular progress bar in a second direction; and
rewind, in response to the rewind input, the playback of the media object according to a length of the second arc, and
un-fill radially, simultaneously with the rewind, the width of the circular progress bar along the second arc to graphically depict the rewinding.

16. The system of claim 10, wherein a central portion of the circular progress bar includes a user-selectable option for pausing and playing the playback of the media object.

17. The system of claim 16, further comprising:
receive, via a user interface of the electronic device, a pause input; and
pause, in response to the pause input, the playback of the media object,
render, at the display and in response to the pause input, an inner circle by extending the inner boundary of the circular progress bar, and
render, at the display and simultaneously with the pause of the media object and the extending of the inner circle, minimizing the first width to a fifth width where the fifth width is less than the first width.

18. The system of claim 17, further comprising:
receive, via a user interface of the electronic device, a play input; and
play, in response to the play input, the playback of the media object,
render, at the display and simultaneously with the play of the media object, removal of the displayed inner circle by unextending the inner boundary of the circular progress bar, and
render, at the display and simultaneously with the play of the media object and the removal of the inner circle, expanding the fifth width to be equal to the first width.

19. A non-transitory medium, readable through a electronic device and including instructions embodied therein that are executable through the electronic device, comprising:
instructions to enable playback of a media object using the electronic device;
instructions to render on a display of the electronic device, a circular progress bar having an inner boundary, an outer boundary, and a first width disposed between the inner boundary and the outer boundary; and
instructions to enable during the playback of the media object, radially filling the width of the circular progress bar to graphically depict a playback progress for the media object.

20. The non-transitory medium of claim 19, further comprising:
instructions to enable automatic download of the media object to a memory of the electronic device if the media object is not currently stored in the memory;
instructions to render a display of a circular download indicator within the first width of the circular progress bar, the circular download indicator having a second width less than the first width of the circular progress bar; and
instructions to radially filling the second width of the circular download indicator to graphically depict a downloading progress for the media object.

21. The non-transitory medium of claim 20, wherein the circular download indicator having a second width equal to the first width of the circular progress bar.

22. The non-transitory medium of claim 19, further comprising:
instructions to receive a volume control input via a user interface of the electronic device, while displaying the circular progress bar; and
instructions to, in response to the volume control input, minimize the first width to a third width and expand a circular volume indicator having a fourth width greater than the third width, the circular volume indicator sharing an inner boundary with the outer boundary of the third width.

23. The non-transitory medium of claim 19, further comprising:
instructions to receive, via a user interface of the electronic device, a fast-forward input moving in a first arc along the circular progress bar in a first direction; and
instructions to, in response to the fast-forward input, simultaneously:
fast-forward the playback of the media object according to a length of the first arc, and
radially fill the width of the circular progress bar along the first arc to graphically depict the fast-forwarding.

24. The non-transitory medium of claim 19, further comprising:
instructions to receive, via a user interface of the electronic device, a rewind input moving in a second arc along the circular progress bar in a second direction; and
instructions to, in response to the rewind input, simultaneously:
rewind the playback of the media object according to a length of the second arc, and
radially un-fill the width of the circular progress bar along the second arc to graphically depict the rewinding.

25. The non-transitory medium of claim 19, wherein a central portion of the circular progress bar includes a user-selectable option for pausing and playing the playback of the media object.

26. The non-transitory medium of claim 25, further comprising:
instructions to receive, via a user interface of the electronic device, a pause input; and
instructions to, in response to the pause input, simultaneously:
pause the playback of the media object,
render a display of an inner circle by extending the inner boundary of the circular progress bar, and
minimize the first width to a fifth width where the fifth width is less than the first width.

27. The non-transitory medium of claim 26, further comprising:
instructions to receive, via a user interface of the electronic device, a play input; and
instructions to, in response to the play input, simultaneously:
play the playback of the media object,
remove the displayed inner circle by unextending the inner boundary of the circular progress bar, and
expand the fifth width to be equal to the first width.
